(19) United States
(12) Patent Application Publication
(10) Pub. No.: US 2012/0069266 A1
(43) Pub. Date: Mar. 22, 2012

(54) LIGHT EMITTING ASSEMBLIES HAVING OPTICAL CONDUCTORS WITH A TAPERED CROSS SECTIONAL SHAPE

(76) Inventors: Jeffery R. Parker, Richfield, OH (US); Kurt R. Starkey, Strongsville, OH (US)

(21) Appl. No.: 13/320,826

(22) PCT Filed: Jun. 2, 2010
(86) PCT No.: PCT/US10/37047

§ 371 Date: Nov. 16, 2011

Related U.S. Application Data
(60) Provisional application No. 61/183,585, filed on Jun. 3, 2009.

(51) Int. Cl. G02F 1/1335; F21V 5/04; F21V 7/00; F21V 21/00

(52) U.S. Cl. 349/61; 362/249.02; 362/235

(57) ABSTRACT

A light emitting assembly (100) has independently operable, planar light emitting modules (400a, 400b), each including an optical conductor (401a, 401b) having a planar front major surface (153), a back major surface (155) opposite the front major surface, a light input surface (422), and a pattern of well defined light extracting optical elements (411). The optical conductor tapers distally from a thicker proximal end (402a, 402b) adjacent the light input surface to a thinner distal end (404a, 404b). An LED light source (420a) located adjacent the light input surface is small relative to the length and width of the optical conductor. The light emitting modules are arranged in tandem with the thinner end of the optical conductor of one light emitting module adjacent the thinner or thicker end of the optical conductor of the next light emitting module, and have front major surfaces that are nominally coplanar.

### TECHNICAL FIELD

Light emitting assemblies include optical conductors that have a tapered cross sectional shape and the ends of two or more optical conductors are aligned.

### BACKGROUND

Most liquid crystal display (LCD) apparatuses employ a light emitting assembly to provide backlighting for an LCD panel that functions as a light valve array. In conventional LCDs, fluorescent lamps, such as cold cathode fluorescent lamps (CCFLs), have been used as light sources in the light emitting assembly. U.S. Pat. No. 6,241,358 (Higuchi et al.) discloses a light emitting assembly having a tandem arrangement of light guides in which each light guide has a tapered cross sectional shape, adjacent light guides are overlapped, and each light guide is illuminated by an elongate light source located near the thicker end of the light guide and is surrounded by a light shield. U.S. Pat. No. 6,464,367 (Ito et al.) discloses a light emitting assembly having a tandem arrangement of light guides in which each light guide has a tapered cross sectional shape, adjacent light guides are overlapped, each light guide is illuminated by an elongate light source located near the thicker end of the light guide, and a light introduction portion is provided between each light source and its corresponding light guide.

There has been increasing use of light emitting diodes (LEDs) as light sources in light emitting assemblies. Japanese patent application publication no. 2006-269364 (Suda, et al.) discloses a light emitting assembly having a tandem arrangement of light guides in which each light guide has a tapered cross sectional shape, adjacent light guides are overlapped, each light guide is illuminated by an array of red, green, and blue LEDs located near the thicker end of the light guide, and a monochromatic light mixing member that is provided between each LED array and its corresponding light guide. United States patent application publication nos. 2008/0205078 and 2008/0205080 disclose a light emitting assembly having a tandem arrangement of light guides in which each light guide has a tapered cross sectional shape, adjacent light guides are overlapped, and each light guide is illuminated by an LED located near the thicker end of the light guide.

### BRIEF DESCRIPTION OF THE DRAWINGS

In the annexed drawings:

FIG. 1 is a schematic top plan view showing an example of a planar light emitting module in accordance with an embodiment of the present invention.

FIG. 2 is a schematic cross sectional view through the planar light emitting module of FIG. 1, taken along the line 2-2 thereof.

FIG. 3 is a schematic cross sectional view showing an example of a light emitting assembly in accordance with an embodiment of the invention.

FIG. 4 is a schematic cross sectional view showing an example of a light emitting assembly in accordance with another embodiment of the invention.

FIG. 5 is a schematic cross sectional view showing a portion of a planar light emitting module in accordance with another embodiment of the present invention.

FIG. 6 is a schematic cross sectional view showing a portion of conductor planar light emitting module in accordance with another embodiment of the present invention.

FIG. 7 is a schematic cross sectional view showing a portion of conductor planar light emitting module in accordance with another embodiment of the present invention.

FIG. 8 is an enlarged schematic plan view showing an example of an LED light source.

FIG. 9 is a schematic cross sectional view through the LED light source shown in FIG. 8, taken along line 9-9 thereof.

FIG. 10 is a schematic plan view showing an example of a light emitting assembly in accordance with another embodiment of the present invention.

FIG. 11 is a schematic plan view showing an example of a light emitting assembly in accordance with another embodiment of the present invention.

FIG. 12 is a schematic plan view showing an example of a light emitting assembly in accordance with another embodiment of the present invention.

FIG. 13 is a schematic plan view showing an example of a light emitting assembly in accordance with another embodiment of the present invention.

FIG. 14 is a graph showing the luminance along a virtual line C-C′ located above the light emitting assembly of FIG. 13 that is substantially uniform.

FIG. 15 is a graph showing the luminance along a virtual line C-C′ located above the light emitting assembly of FIG. 13 that varies gradually between end points at opposite ends of the assembly.

FIG. 16 is an enlarged schematic top plan view showing one of the planar light emitting modules of the light emitting assembly shown in FIG. 13.

FIG. 17 is a schematic cross sectional view through the light emitting module of FIG. 16, taken along line 17-17 thereof.

FIG. 18 is a schematic cross sectional view showing an example of a light emitting assembly in accordance with another embodiment of the present invention composed of the light emitting modules of FIGS. 16 and 17.

FIG. 19 is a schematic plan view showing an example of a light emitting assembly in accordance with another embodiment of the present invention.

FIG. 20 is a schematic cross sectional view showing an example of a light emitting assembly in accordance with another embodiment of the present invention.

FIG. 21 is schematic cross sectional view showing an example of a light emitting assembly in accordance with another embodiment of the present invention.

### DETAILED DESCRIPTION

Embodiments of the present invention relate to light emitting assemblies having planar light emitting modules each including an optical conductor and an LED light source. Each optical conductor has a cross sectional profile that is tapered with a thicker end and a thinner end. Each optical conductor includes a light input surface and well defined light extracting optical elements on or in the optical conductor. The optical elements are configured to redirect light received at the light input surface out from the optical conductor. The LED light source is located adjacent the light input surface, and is small relative to the length and width of the optical conductor. In one embodiment, the planar light emitting modules are arranged in tandem with the thinner end of the optical conductor of one of the light emitting modules adjacent the thicker end of the optical conductor of an adjacent one of the planar light emitting modules, and the front major surfaces of the optical conductors nominally coplanar. In another embodiment, the optical conductors are arranged in tandem with the thinner end of the optical conductor of the one of the planar light emitting modules adjacent the thinner end of the optical conductor of another adjacent one of the planar light emitting modules, and the light emitting surfaces of the optical conductors nominally coplanar. In another embodiment, the optical conductors constitute respective sections of an optical conductor having a tapered cross sectional shape within each section. A light transmission reduction element may be positioned between the adjacent ends of the optical conductors to make the optical conductors independently operable.

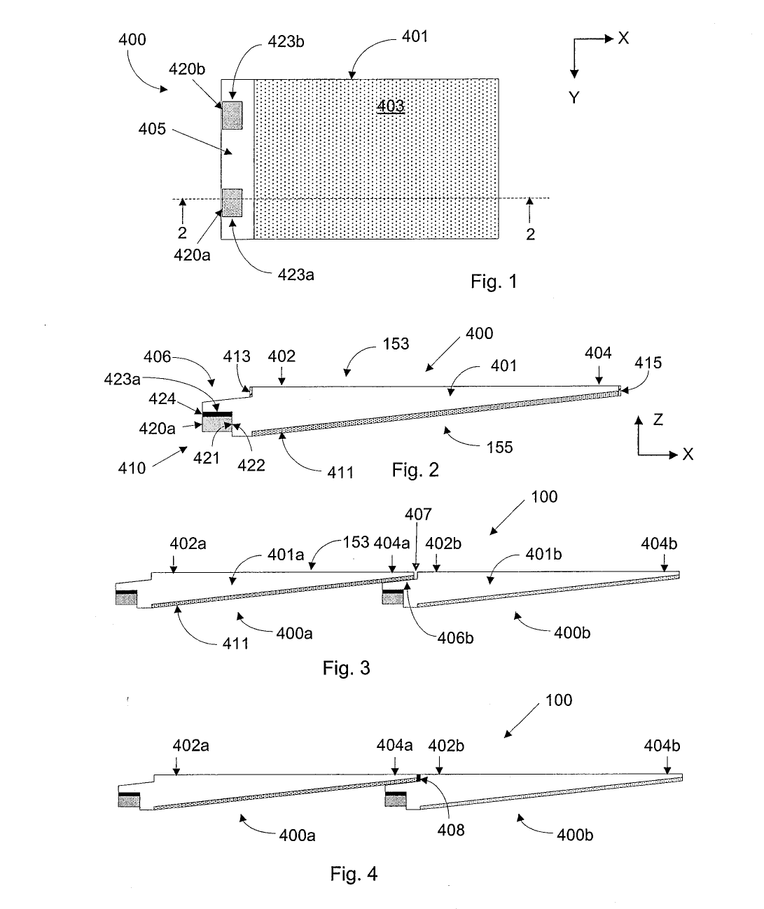

Embodiments of the present invention will now be described in detail with reference to the Figures. FIG. 1 is a schematic plan view showing an example of a planar light emitting module 400 in accordance with an embodiment of the invention. Planar light emitting module 400 is composed of a planar optical conductor 401, and one or more LED light sources located adjacent a side of the optical conductor. In some embodiments, the optical conductor is made from such plastic materials as polycarbonate and poly(methyl methacrylate) (PMMA). In some embodiments, light source housings are defined in the optical conductor adjacent one side of the optical conductor. In the example shown, light source housings 423a, 423b are defined in optical conductor 401 adjacent one side of the optical conductor. In other examples, more or fewer light source housings than the number shown are defined in the optical conductor.

In the example shown in FIG. 1, one or more LED light sources are mounted in each of the light source housings defined in optical conductor 401. In the example shown, LED light sources 420a, 420b are mounted in light source housings 423a, 423b, respectively. Each LED light source 420a, 420b includes at least one light emitting diode (LED). Each LED light source may additionally include one or more of a lens, a diffractive optical element, a reflector and a phosphor. In an example, the LEDs constituting each light source 420a, 420b are of different colors that combine to produce white light. In another example, the LEDs are all of the same color, which may be white. In this example, an LED and a phosphor that converts the light emitted by the LED to white light are combined in the same package. The number of LEDs constituting each LED light source is not restricted. In the width direction of optical conductor 401, i.e., the Y-direction shown in FIG. 1, the LEDs are small compared with the length and width of optical conductor 401. In an example, the LEDs have linear dimensions less than one-tenth of the length and width of the optical conductor.

Optical conductor 405 additionally includes a transition region 405 between light source housings 423a, 423b and a light emitting region 403 (described below) where light from LED light sources 420a, 420b mounted in the light source housings can mix and/or spread.

FIG. 2 shows a schematic cross sectional view of planar light emitting module 400, taken along line 2-2 of FIG. 1. In planar light emitting module 400, optical conductor 401 has a front major surface 153 and a back major surface 155 opposite light emitting major surface 153. When planar light emitting module 400 is arranged to illuminate an LCD panel (not shown), front major surface 153 faces the LCD panel and back major surface 155 is remote from the LCD panel. Optical conductor 401 also has a light input surface. In the example shown, a respective portion of a light input surface 422 is located in each light source housing 423a, 423b.

Located on or in the back major surface 155 of optical conductor 401 is a pattern of well-defined light extracting optical elements 411 (not individually shown) that direct light received at light input surface 422 out of the optical conductor by refracting and/or reflecting the light. Examples of suitable well defined optical elements are described in U.S. Pat. No. 6,752,505, assigned to the assignee of this disclosure, the disclosure of which, in the United States at least, is incorporated by reference. The optical elements are small, and are typically very small, compared with the length and width of optical conductor 401. In an example, the optical elements have dimensions of the order of tens of micrometers, whereas optical conductor 401 has dimensions of the order of centimeters or tens of centimeters. In the example shown, the optical elements located on or in the back major surface 155. In other examples, the optical elements are located on or in the front major surface 153, in the interior of the optical conductor, or on or in both of the front and back major surfaces 153, 155.

Optical conductor 401 includes a light emitting region 403 from which light is emitted from front major surface 153. The location of the pattern of optical elements 411 defines the location of the light emitting region 403. The optical elements vary in one or more of area density, number density, size, shape, height, and depth in a manner that makes the light emitted from light emitting region 403 uniform in intensity.

Located adjacent back major surface 155 is a reflective element (not shown) that reflects light emitted from back major surface 155 to the optical conductor. The returned light is then re-emitted from front major surface 153. The reflective element is embodied as a reflective layer, sheet, film, or substrate. Additionally, a light conditioning element (not shown) can be located adjacent front major surface 153. The light conditioning element is typically composed of one or more, or multiple ones, of a diffuser film, a diffuser plate, and a prismatic film.

As noted above, the optical elements 411 vary in one or more of number density, area density, size, height, and depth within a region (not shown) aligned with light emitting region 403. In transition region 405 or in a region (not shown) aligned with the transition region, either or both of the area density and number density of the optical elements is typically negligible, or is substantially smaller than the corresponding property of the optical elements within the region aligned with light emitting region 403. In an embodiment, there are no optical elements within the region aligned with transition region 405.

As noted above, optical conductor 401 has a light input surface at or adjacent one of its sides. In the example shown, a portion of light input surface 422 is located in each light source housing 423a, 423b. LED light source 420a mounted in light source housing 423a has a light emitting surface 421 that faces light input surface 422. In the example shown, light source housing 423a is configured as an open-ended recess 410. The LED light source is electrically connected to a circuit board (not shown), which may be located adjacent the back major surface 155 of the optical conductor. Light enters optical conductor 401 and some of the light is refracted or reflected by optical elements 411 to direct the light out of the optical conductor through front major surface 153.

An opaque layer is located on or in the optical conductor adjacent the LED light source to block stray light from the LED light source. In the example shown, an opaque layer 424 is located within light source housing 423a and is disposed parallel to front major surface 153. In an example, the opaque layer reflects light. In another example, the opaque layer absorbs light.

In a plane orthogonal to front major surface 153, the optical conductor 401 has a tapered cross sectional shape. The tapered cross sectional shape increases the fraction of the light generated by LED light sources 420a, 420b that is emitted from the front major surface. The tapered cross sectional shape may additionally or alternatively improve the uniformity of intensity of the light emitted from light emitting region 403. Optical conductor 401 has a thickness in the above-mentioned plane. The thickness decreases distally from light source housings 423a, 423b, so that a distally-located thinner portion 404 of the optical conductor is thinner than a proximally-located thicker portion 402.

In the proximal portion 402 of optical conductor 401, front major surface 153 includes a step that defines an open-ended recess 406. Recess 406 will be further described with reference to FIG. 3, which is a cross sectional view showing an example of a light emitting assembly 100 in accordance with an embodiment of the invention. Light emitting assembly 100 is composed of two instances 400a, 400b of planar light emitting module 400 arranged in tandem with the distal portion 404a of the optical conductor 401a of planar light emitting module 400a accommodated within the recess 406b defined in the proximal portion 402b of the optical conductor 401b of the planar light emitting module 400b. Overlapping the light source housing of optical conductor 401b with the distal portion 404a of optical conductor 401a maximizes the light emission area of light emitting assembly 100. The overlapped tandem arrangement of optical conductors 401a, 401b forms an almost continuous, nominally planar light emitting surface extending from the proximal portion 402a of first optical conductor 401a to the distal portion 404b of second optical conductor 401b. The light emitting region of the light emitting assembly is almost twice as wide as that of the individual planar light emitting modules 400. Additional instances (not shown) of planar light emitting module 400 may be arranged in tandem with planar light emitting modules 400a, 400b to further increase the width of the light emitting region.

Planar light emitting modules 400a, 400b are positioned such that the distal end of optical conductor 401a and the distal end of recess 406b in the proximal portion 402b of the optical conductor 401b are separated by a gap 407. Gap 407 reduces the transmission of light between the first and second planar light emitting modules 400a, 400b. In the example shown in FIG. 3, gap 407 is an air gap.

FIG. 4 shows an alternative configuration of light emitting assembly 100 in which gap 407 is filled with opaque material 408 that prevents the transmission of light between planar light emitting modules 400a, 400b. In an example, opaque material 408 is light absorbing material, e.g., black material inserted or deposited into gap 407. In another example, opaque material is reflective material, e.g., reflective metal inserted or deposited into gap 407.

FIG. 2 shows an optional coating 413, 415 on the distal side 415 of the optical conductor 401, and on the distal side of recess 406 in proximal region 402. In an example, optical coating 413, 415 is reflective. In another example, optical coating 413, 415 is light absorbing. Typically, optical coating 413, 415 is deposited on or attached to the optical conductor 401 of each planar light emitting module 400 before the planar light emitting modules are assembled in the above-described tandem arrangement. Gap 407, light absorbers, and reflectors are examples of what will be referred to herein as light transmission reduction elements between the adjacent planar light emitting modules.

Light transmission reduction elements and at least one LED light source coupled to the optical conductor of each planar light emitting module enable the planar light emitting modules to be operated independently. Such independent operation allows the intensity of the light emitted by each planar light emitting module to be controlled independently of the intensity of the light emitted by an adjacent planar light emitting module. Independent operation enables localized dimming, localized boosting, and scanning backlight in liquid crystal display apparatuses. The light emitting modules are typically operated independently by independently defining a characteristic of the light generated by the LED light sources optically coupled to the optical conductor of each light emitting module. In an example, the effective intensity of the light generated by the LED light sources optically coupled to each light emitting module is defined by a current, a voltage, a current pulse duty cycle, a voltage pulse duty cycle, or another property of the drive applied thereto. In another example, the color of the light is independently defined for each light emitting module. This can be done, for example, by optically coupling red, green and blue LED light sources to each light emitting module and controlling the drive applied to the LED light sources of each color.

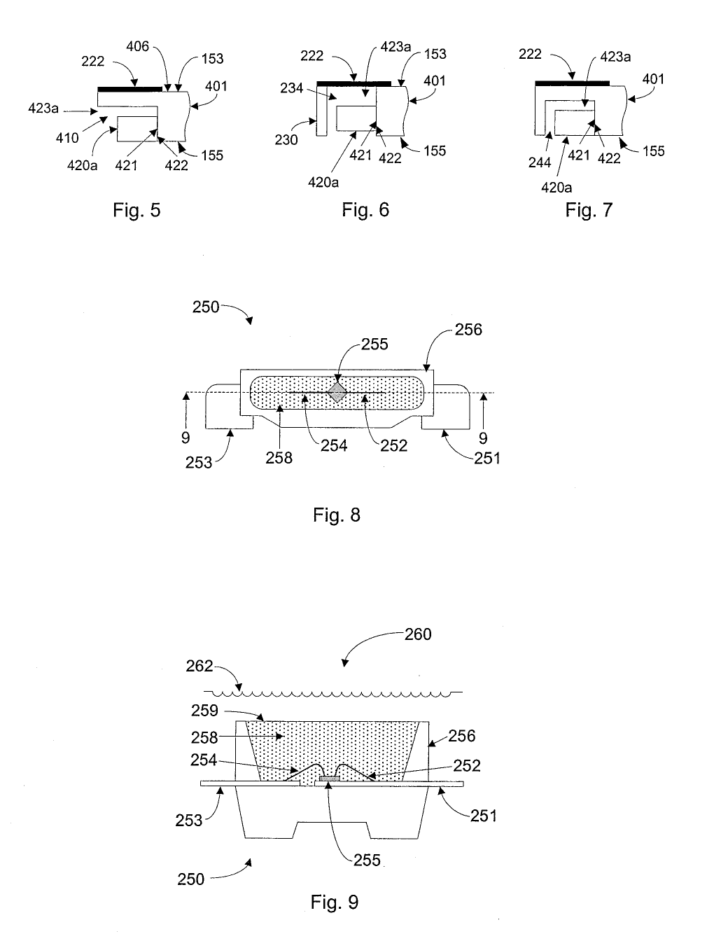

FIG. 5 shows an alternative configuration of optical conductor 401 described above with reference to FIGS. 2 and 3. In this embodiment, and in the embodiments shown in FIGS. 6 and 7, opaque layer 222 is located on the surface of recess 406 approximately parallel to front major surface 153.

FIGS. 6 and 7 show two alternative configurations of light source housing 423a. FIG. 6 shows an example of light source housing 423a configured as a hole 234 that extends between the front and back major surfaces 153, 155 of the optical conductor. LED light source 420a is mounted in hole 234 with its light output surface 421 facing the light input surface 422 of optical conductor 401. The side wall of hole 234 serves as light input surface 422 in this configuration.

FIG. 7 shows an example of light source housing 423a configured as a cavity 244 that extends into optical conductor 401 from the back major surface 155 of the optical conductor. LED light source 420a is mounted in cavity 244 with its light output surface 421 facing the light input surface 422 of optical conductor 401. The side wall of cavity 244 serves as light input surface 422 in this configuration. Alternatively, the cavity extends from the front major surface 153 of the optical conductor. In an example, cavity 244 is configured as a slot, i.e., a cavity that is substantially longer and deeper than it is wide.

An LED light source that constitutes part of a planar light emitting module in accordance with embodiments of the present invention has a light output distribution defined by a greater width component than height component, where, when the LED light source is mounted in optical conductor 401, the height component of the light output distribution is orthogonal to the front major surface 153 of the optical conductor. An example of an LED light source with this emission characteristic is a side-view type LED light source that has a mounting surface approximately orthogonal to its light emission direction.

FIG. 8 is a schematic plan view showing an example of an LED light source 250 suitable for use in a planar light emitting module in accordance with an embodiment of the invention. FIG. 9 is a schematic cross sectional view taken along line 9-9 in FIG. 8.

In LED light source 250, first and second plate-like leads 251, 253 are positioned with their ends adjacent, and an LED chip 255 is bonded to a surface of first lead 251 near its end adjacent lead 253. The electrodes of the LED chip are electrically connected via wires 252, 254 to the first and second leads respectively. In this example, the LED chip does not have a bottom electrode. The first and second leads 251, 253 are fixed in position by a white resin body 256. The LED chip is located in the concave portion of resin body 256. The concave portion is filled with a transparent resin 258 through which light travels before it reaches a light output surface 259. In the case of a white LED light source, down-conversion material, such as a phosphor, is added to the transparent resin 258. LED light source 250 typically has a height less than or equal to the thickness of the portion of the optical conductor in or on which it is mounted. This allows light emitting assembly 100 (FIG. 3) to have a thin profile.

Additionally shown in FIG. 9 is a light input surface 260 of an optical conductor. The light input surface has a microlens array 262 located adjacent the light output surface 259 of the LED light source when the LED light source is mounted in or on the optical conductor. The microlens array couples and distributes the light generated by the LED light source into the optical conductor. For simplicity of illustration, the microlens array has been omitted from the other Figures that show a light input surface. However, the microlens array can be used beneficially in all of the embodiments shown.

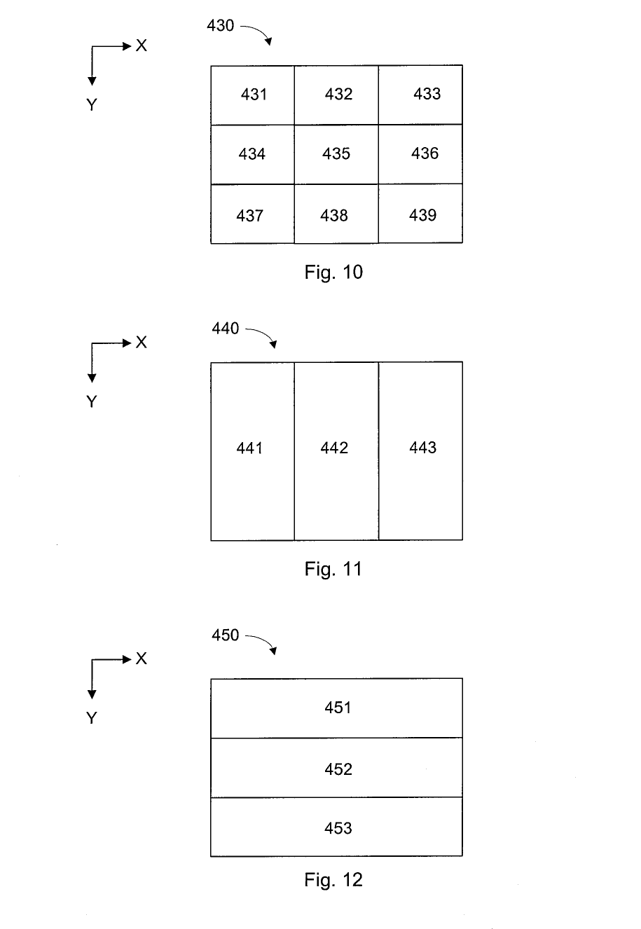

A light emitting assembly can be assembled from a 1-dimensional or 2-dimensional array of planar light emitting modules similar to planar light emitting module 400 described above with reference to FIGS. 2-4. Alternatively, a single such planar light emitting module can constitute an entire light emitting assembly. FIG. 10 is a schematic plan view showing a light emitting assembly 430 composed of a 2-dimensional, 3×3 array of planar light emitting modules 431-439. FIG. 11 is a schematic plan view showing a light emitting assembly 440 composed of planar light emitting modules 441-443 arrayed only in the X direction. FIG. 12 is a schematic plan view showing a light emitting assembly 450 composed of planar light emitting modules 451-453 arrayed only in the Y direction. In the light emitting assemblies shown in FIGS. 10-12, each planar light emitting module is similar to above-described planar light emitting module 400.

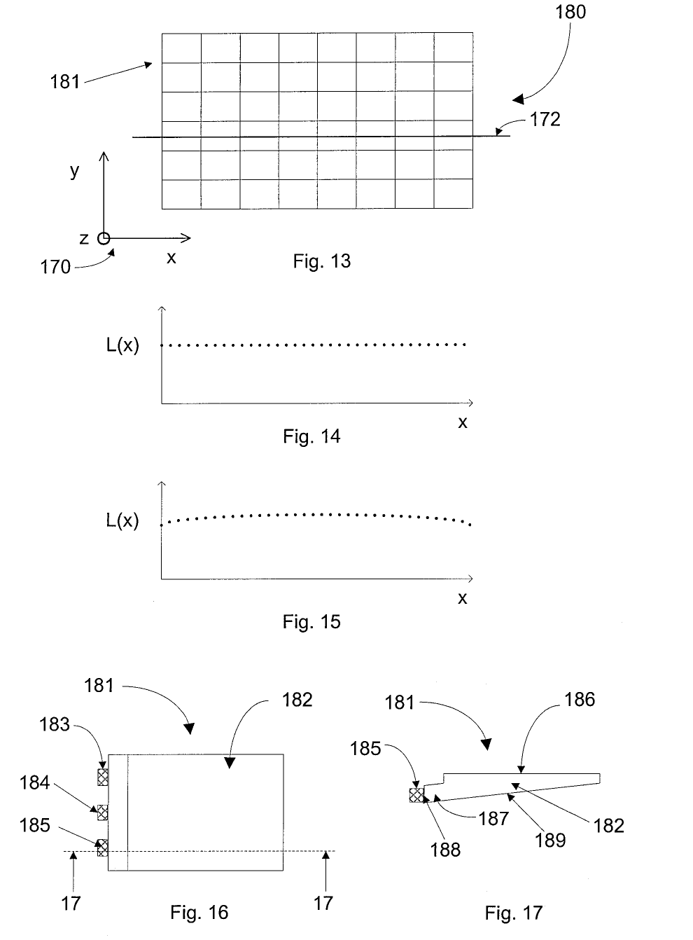

FIG. 13 is a schematic plan view showing a light emitting assembly 180 for a 37 inch class liquid crystal display (LCD) high definition TV in accordance with an embodiment of the present invention. An x-y-z coordinate system 170 is also shown. Light emitting assembly 180 has a viewable area of approximately 81.9 cm (x-direction) by 46.1 cm (y-direction), and is composed of 48 planar light emitting modules 181. Each planar light emitting module 181 has a viewable area of approximately 10.24 cm (x-direction) by 7.68 cm (y-direction), i.e., each planar light emitting module has an aspect ratio of 4:3. In light emitting assembly 180, each planar light emitting module 181 is composed of one or more LED light sources, an optical conductor including a pattern of well defined light extracting optical elements, and, if needed, other optical films or substrates such as reflectors, diffusers, and lenticular prismatic films. Thee above-mentioned dimensions are illustrative, the light emitting assembly and its constituent planar light emitting modules can have sizes and aspect ratios different from those exemplified above.

FIG. 16 is a schematic plan view showing an example of planar light emitting module 181 in greater detail. FIG. 17 is a schematic cross sectional view of planar light emitting module 181, taken along line 17-17 of FIG. 16. In planar light emitting module 181, no light source housings are defined in optical conductor 182. Instead, LED light sources 183, 184, and 185 are attached to the light input surface 188 of optical conductor 182. LED light sources 183, 184, and 185 can be white LEDs or red, green, and blue LEDs. The number of LED light sources may be more or less than the three LED light sources shown.

A pattern of well defined light extracting optical elements similar to optical elements 411 of optical conductor 401 is located on or in optical conductor 182. In the example shown, the optical elements are located in a light emitting portion of front major surface 186. Planar light emitting module 181 may additionally include a light conditioning element (not shown). Such a light conditioning element is compose of one or more of, or multiple ones of, such optical films, sheets, or substrates as a diffuser film, sheet, or substrate and a lenticular prism film, sheet, or substrate. In some embodiments, optical conductor 182 has a multilayer structure that integrally incorporates the pattern of optical elements and the light conditioning element. In other embodiments, optical conductor 182 is hollow. Alternatively, the above-mentioned light conditioning element can be mounted parallel to the front major surface of the array of light emitting modules. In addition, a reflective element can be located adjacent the back major surface 189 of optical conductor 182.

In an example, LED light sources 183-185 are bonded or otherwise permanently attached to light input surface 188 such that air gaps between the light output surfaces of the LED light sources and light input surface 188 are substantially eliminated. In some embodiments, light input surface 188 is coated with an antireflective coating to enhance light input in a defined wavelength range. In some embodiments, either or both of light input surface 188 and the light output surfaces of LED light sources 185 include a microlens array to direct the light in defined directions or to spread and/or mix the light.

Upon entering optical conductor 182 via light input surface 188, light from LED light sources 182-185 travels through a transition region 187 and then reaches front major surface 186. The light spreads, or light from adjacent LED light sources mixes in the transition region. In some embodiments, the pattern of well defined optical elements is formed on or in front major surface 186. In other embodiments, the pattern of well-defined optical elements is located on back major surface 189, or on both front major surface 186 and back major surface 189. In some embodiments, variations in refractive index are provided in transition region 187 to direct the light from the LED light source in defined directions.

In the example shown, in a plane orthogonal to front major surface 186, optical conductor 182 has a tapered cross sectional profile whose thickness decreases distally from LED light sources 182-185. Optical conductor 182 may alternatively have a substantially constant thickness except at its ends, where the thickness is reduced to define a recess extending into the optical conductor from the top major surface at one end and a recess extending into the optical conductor from the bottom major surface at the other end. Such recesses permit the optical conductors of adjacent planar light emitting modules to overlap when the planar light emitting modules are arranged in tandem, and accommodate the LED light sources. In the example shown in FIG. 17, LED light sources 182-185 are attached to, or are otherwise mounted adjacent a side surface of optical conductor 182 that provides light input surface 188. In this and the other embodiments described herein, the light input surface is nominally orthogonal to front major surface 186, although orientations differing by as much as ±20 degrees from orthogonal can be used. Alternatively, as described above with reference to FIGS. 2-7, one or more light source housings may be defined in optical conductor in which the LED light sources are mounted.

FIG. 13 shows a virtual line 172 along which the intensity L(x) of the light emitted by the light emitting assembly 180 measured. Virtual line 172 extends in the x-direction and is offset a defined distance in the z-direction from the front major surface of the light emitting assembly. FIG. 14 is a graph showing the variation of intensity L(x) along the line 170 in a first intensity characteristic in which the intensity measured along line 170 is substantially uniform. The intensity is measured when all of the LED light sources of the light emitting assembly are in the steady-state ON state. The LED light sources generate light in response to prescribed electrical inputs, e.g., voltage, current. In some examples, the electrical inputs differ among the LED light sources. The differences in the electrical inputs among the LED light sources compensates for differences in the electrical to light conversion efficiencies of the LED light sources. In some embodiments, prescribed electrical input values that generate light of a defined intensity are stored in a look-up table (LUT) and the stored values are updated from time to time to compensate for differences in the aging characteristics of the LED light sources.

FIG. 15 is a graph showing the variation of intensity L(x) along the line 172 in a second intensity characteristic in which the intensity is within a prescribed range of a mean intensity and the intensity varies gradually from one side of the light emitting assembly to the other side of the light emitting assembly. The second intensity characteristic is typical of LCD TVs that are slightly brighter near the middle of the display. Such an intensity profile is more pleasing to some viewers. Intensity measurements are typically performed along virtual lines extending across the light emitting assembly in both the x- and y-directions.

In conventional light emitting assemblies in which the intensity cannot be made to be as uniform as desired, it is possible to compensate for the non-uniformity. This compensation can be done by characterizing the intensity profile of the light emitting assembly and storing corresponding correction factors for small regions of the light emitting assembly in a look-up table (LUT). Each correction factor depends on the luminance profile data. Portions of the incoming video signal pertaining to corresponding small regions of the picture are then multiplied by a corresponding correction factor to correct for the non-uniformity of the illumination intensity.

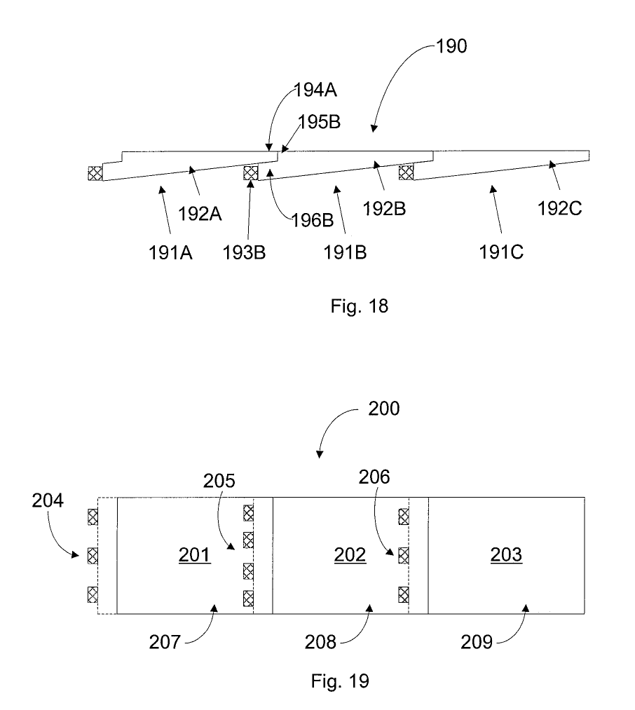

FIG. 18 is a schematic cross sectional view showing a light emitting assembly 190 composed of planar light emitting modules 191A, 191B, 191C arranged in tandem. Each planar light emitting module 191A, 191B, 191C includes an optical conductor 192A, 192B, 192C, respectively. Each planar light emitting module 191A, 191B, 191C includes at least one LED light source that illuminates optical conductor 192A, 192B, 192C, respectively. The planar light emitting modules are arranged in tandem such that distal portion 194A of left-most optical conductor 192A extends over adjacent LED 193B and the transition region 196B of adjacent optical conductor 192B. The patterns of well defined light extracting optical elements (not shown) on or in the optical conductors are configured so that discontinuities in the patterns are minimized between distal portion 194A and proximal portion 195B. Furthermore, this tandem arrangement method locates the distal portion of the optical conductor of each planar light emitting module in front of the LED light sources and the transition region of the adjacent planar light emitting module. This reduces the overall thickness of the light emitting assembly. In the example shown in FIG. 18, the LED light sources of each planar light emitting module are attached to a light input surface on the side of the optical conductor. Alternatively, as described with reference to FIGS. 2-7, one or more light source housings may be defined in the optical conductor in which the LED light sources are mounted.

It is not necessary that each planar light emitting module be illuminated by the same number of LEDs. FIG. 19 is a schematic plan view showing a light emitting assembly 200 composed of planar light emitting modules 201, 202, 203 arranged in tandem. Each planar light emitting module 201, 202, 203 includes an optical conductor 207, 208, 209, respectively. Planar light emitting modules 201, 203 each include three LED light sources identified by reference numerals 204, 206, respectively, that illuminate optical conductors 207, 209, respectively. Planar light emitting module 202 includes four LED light sources identified by reference numeral 205 that illuminates optical conductor 208.

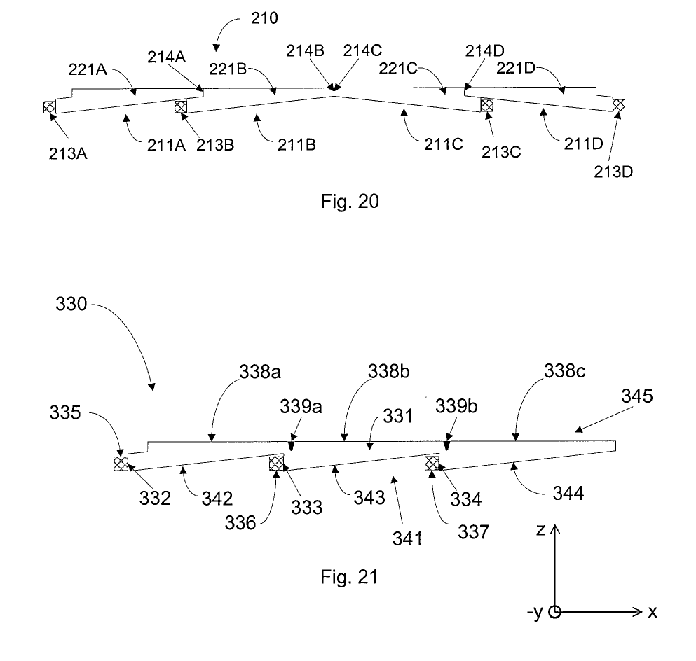

Moreover, FIGS. 18 and 19 show embodiments of light emitting assemblies in which LED light sources are arranged along the left side of each light emitting module such that the LED light source emit light towards the right. However, not all of the LEDs need emit light in the same general direction. FIG. 20 is a schematic cross sectional view showing an example of a light emitting assembly 210 in which the planar light emitting modules are arranged such that their respective the LED light sources emit light in opposite directions. Light emitting assembly 210 is composed of planar light emitting modules 211A, 211B, 211C, 211D. Each planar light emitting module 211A, 211B, 211C, 211D includes an optical conductor 221A, 221B, 221C, 221D respectively. Each planar light emitting module 211A, 211B includes LED light sources 213A, 213B, respectively, that emit light towards the right. Each planar light emitting module 211C, 22D includes LED light sources 213C, 213D, respectively,) associated with light emitting modules that emit light to the left.

In light emitting assembly 210, the distal region 214B of planar light emitting module 211B and the distal region 214C of planar light emitting module 211C are configured to minimize discontinuities in the pattern of optical elements between optical conductors 221B, 221C.

In some embodiments, LED light sources are additionally or alternatively located on one or both of the sides of the respective optical modules orthogonal to the side on which LED light sources 213A-213D are shown. In other embodiments, some of the LED light sources are oriented angles different from others of the LED light sources to direct light in different directions. In other embodiments, the front major surface of the optical conductor is other than rectangular in shape. For example, in such embodiments, the front major surface is triangular, hexagonal or trapezoidal in shape.

FIG. 21 is a schematic cross sectional view showing an example of a planar light emitting module 330 in accordance with another embodiment of the present invention. In this embodiment, the optical conductors constitute respective sections of a single, large optical conductor having a tapered cross sectional shape within each section. Planar light emitting module 330 includes an optical conductor 331 having a repetitive tapered cross sectional profile in which the rear major surface 341 of the optical conductor has a saw tooth shape with tilted plane surfaces 342, 343, 344 linked by intermediate surfaces 333, 334. Intermediate surfaces 333, 334 are nominally orthogonal to front major surface 345. In the example shown, intermediate surfaces 333, 334 together with surface 332 provide the light input surfaces of optical conductor 331. Less mechanical assembly work needed to assemble a light emitting assembly from instances of planar light emitting module 330 than from planar light emitting modules similar to, e.g., planar light emitting modules 191A-191C described above with reference to FIG. 18. LED light sources 335, 336, and 337 are attached to or located adjacent respective light input surfaces 332, 333, 334. Alternatively, as described with reference to FIGS. 2-7, one or more light source housings may be defined in optical conductor 331 adjacent each of the surfaces 332, 333, 334 in each of which the LED light sources are mounted.

Light transmission reduction elements 339a, 339b are defined in optical conductor to divide the optical conductor into light emitting regions 338a, 338b, and 338c, each of which is independently operable because it is illuminated by respective ones of LED light sources 335, 336, and 337 and is optically isolated by the light transmission reduction elements. In this example, each light transmission reduction element 339a, 339b is configured as a groove that extends into optical conductor 331 from the front major surface 345 thereof. The groove extends across optical conductor 331 in the Y-direction. In the X-direction, the location of each groove corresponds to light input surface 333, 334, respectively, or, as in the example shown, such location is slightly offset in the X-direction from the light input surface.

The respective groove providing each light transmission reduction element 339a, 339b is filled with opaque material (e.g., black material). Alternatively, each groove may be left unfilled to provide an air gap, or may be filled or coated with a reflective material or may be filled or coated with a material having a refractive index lower than that of the optical conductor. Alternatively, each light transmission reduction element may be an elongate region of lower refractive index material located within the optical conductor or may be implemented as a groove located on or in the back major surface 341 of the optical conductor.

This disclosure describes the invention in detail using illustrative embodiments. However, the invention defined by the appended claims is not limited to the precise embodiments described.

1. A light emitting assembly, comprising:
independently operable, planar light emitting modules, each comprising:
an optical conductor comprising a planar front major surface, a back major surface opposite the front major surface, a light input surface, and a pattern of well defined light extracting optical elements on or in the optical conductor, the optical elements configured to redirect the light received at the light input surface out from the optical conductor, the optical conductor having a length, a width, and a cross sectional profile that tapers distally from a thicker proximal end adjacent the light input surface to a thinner distal end; and
a light emitting diode (LED) light source located adjacent the light input surface, the LED light source being small relative to the length and width of the optical conductor;
in which the light-emitting modules are arranged in tandem with the thinner end of the optical conductor of one of the light emitting modules adjacent the thicker end of the optical conductor of an adjacent one of the light emitting modules, and the front major surfaces of the optical conductors nominally coplanar.

2. The light emitting assembly of claim 1, in which the distal end of the optical conductor of the one of the light emitting modules partially overlaps the proximal end of the optical conductor of the adjacent one of the light emitting modules.

3. The light emitting assembly of claim 1, additionally comprising a light transmission reduction element located between the distal end of the optical conductor of the one of the light emitting modules and the proximal end of the optical conductor of the adjacent one of the light emitting modules.

4. The light emitting assembly of claim 1, in which the light-emitting modules are additionally arranged in tandem with the thinner end of the optical conductor of the one of the light emitting modules adjacent the thinner end of the optical conductor of another adjacent one of the light emitting modules.

5. The light emitting assembly of claim 4, additionally comprising a light transmission reduction element located between the distal end of the optical conductor of the one of the light emitting modules and the distal end of the optical conductor of the adjacent one of the light emitting modules.

6. The light emitting assembly of claim 1, in which the optical conductors are respective sections of a single optical conductor having a tapered cross sectional shape within each section.

7. The light emitting assembly of claim 6, in which:
the sections comprise a first section and a second section, adjacent the first section; and
the light emitting assembly additionally comprises a light transmission reduction element between the first section and the second section.

8. The light emitting assembly of claim 1, in which:
the LED light source is configured to generate light having an output distribution defined by a greater width component than height component; and
the height component of the output distribution is nominally orthogonal to the front major surface of the optical conductor.

9. The light emitting assembly of claim 1, in which:
the optical conductor additionally comprises a light source housing defined therein adjacent the light input surface; and
the LED light source is mounted in the light source housing.

10. The light emitting assembly of, claim 1, in which at least some of the light extracting optical elements are small relative to the length and width of the optical conductor.

11. The light emitting assembly of claim 1, in which at least one of the light input surface and the LED light source comprises a lens array.

12. The light emitting assembly of claim 1, in which the optical conductor additionally comprises additional LED light sources located adjacent the light input surface.

13. The light emitting assembly of claim 12, in which the optical conductor additionally comprises a transition region adjacent the light input surface, the transition region configured to spread and mix the light from the LED light sources.

14. The light emitting assembly of claim 1, additionally comprising an optical sheet, film, or substrate adjacent at least one of the major surfaces of the optical conductor.

15. The light emitting assembly of claim 14, in which the additional optical sheet, film, or substrate comprises at least one of a diffuser layer, a brightness enhancement layer, a prismatic layer, a textured layer, and a pattern of optical deformities.

16. The light emitting assembly of claim 1, additionally comprising a reflective element adjacent the back major surface of the optical conductor.

17. A liquid crystal display apparatus, comprising a liquid crystal panel disposed to receive light emitted from the light emitting assembly of claim 1.
